(19) United States
(12) Patent Application Publication
(10) Pub. No.: US 2025/0111131 A1
(43) Pub. Date: Apr. 3, 2025

(54) System and Method for Accessing a Rich Communication Services (RCS) Business Messaging (RBM) Agent

(71) Applicant: Gupshup Inc, FREMONT, CA (US)

(72) Inventor: Surinder Singh Anand, Highland, NJ (US)

(21) Appl. No.: 18/903,039

(22) Filed: Oct. 1, 2024

Related U.S. Application Data
(60) Provisional application No. 63/587,447, filed on Oct. 2, 2023.

(51) Int. Cl. G06F 40/14; H04L 51/02

(52) U.S. Cl. CPC G06F 40/14; H04L 51/02

(57) ABSTRACT

A method and a system for accessing a rich communication services (RCS) Business Messaging (RBM) agent is disclosed. The method employs a rich communication services person-to-application (RCSP2A) to receive RBM agent information comprising a chatbot_service_id, a chatbot_name, and a trigger_keyword of the RBM agent, and to create a person-to-application (P2A) deep-link for the RBM agent. The RCSP2A transmits the created P2A deep-link to a user. Upon the user clicking the P2A deep-link, if the user is an android user with a RCS enabled device, the RCSP2A initiates a chat with the RBM Agent specified by the chatbot_service_id and the chatbot_name in the intent: uniform resource identifier, with the trigger_keyword pre-populated. The user can one of start chatting or resume chatting with the RBM agent. The system comprises at least one processor, a non-transitory, computer-readable storage medium and the RCSP2A.

### CROSS-REFERENCE TO RELATED APPLICATION

This application claims the benefit of provisional patent application No. 63/587,447, titled “System and Method for Creating Person-to-Application (P2A) Links for Users to Access an RCS Business Messaging (RBM) Agent”, filed in the United States Patent and Trademark Office on Oct. 2, 2023. The specification of the above referenced patent application is incorporated herein by reference in its entirety.

### BACKGROUND

A chatbot is a software application designed to simulate human conversation through text or voice interactions. In banking, chatbots are used to provide 24/7 customer support, handle routine inquiries and transactions, such as checking account balances, transferring funds, and updating personal information. An example of a person-to-application (P2A) uniform resource locator (URL) for a rich communication services (RCS) chatbot, which is assigned a chatbot service identifier (ID) is “bot@botplatform.example.com”. To initiate a conversation, the chatbot requests the user to send the message “tell me about checking accounts”. The deep link uniform resource locator (URL) for this interaction can be: “sms: bot@botplatform.example.com&body=tell % 20me%20 about%20checking%20accounts.”. When this deep link is activated by an RCS client, a message with the chatbot, identified by the service ID, will be prepared for the user to send via RCS.

Furthermore, the Messages application on an Android device supports a uniform resource locator (URL) with the following format for initiating a conversation with a chatbot, such as a rich business messaging (RBM) Agent: ‘sms: <chatbot_service_id>?bot-name=<chatbot_name>&body=<initial_msg>’. For example, a URL for Dotgo Football Club's RBM Agent would be: “sms: dotgo-football-club@rbm.goog?bot-name=Football+Club&body=start”. There are variations of the ‘sms:’ protocol that also work: 1) ‘smsto:’, 2) ‘mms:’, and 3) ‘mmsto:’. While a URL with the ‘sms:’ protocol works for users with an Android device and an RCS-enabled client set as the default SMS client, it has several limitations for users with other setups.

Hence, there is a long-felt need for a method to create and transmit person-to-application (P2A) deep-links that works for a wide range of users, including those with user devices that are: 1) non-Android devices, 2) Android devices with an RCS-enabled messages client, set as the default SMS application, allowing users to initiate a conversation with the RBM agent, 3) Android devices without the messages client installed, 4) Android devices with the messages client installed but not enabled for RCS, and 5) Android devices with the messages client installed but not set as the default SMS application.

### BRIEF DESCRIPTION OF THE DRAWINGS

The foregoing summary, as well as the following detailed description of the invention, is better understood when read in conjunction with the appended drawings. For illustrating the embodiments herein, exemplary constructions of the embodiments are shown in the drawings. However, the embodiments herein are not limited to the specific methods and components disclosed herein. The description of a method step or a component referenced by a numeral in a drawing is applicable to the description of that method step or that component shown by that same numeral in any subsequent drawing herein.

FIGS. 1A-1G illustrate flowcharts of a method for accessing a rich communication services (RCS) business messaging (RBM) agent.

FIG. 2 exemplarily illustrates an architectural block diagram of an exemplary implementation of a system for accessing a rich communication services (RCS) Business Messaging (RBM) agent.

FIGS. 3A-3C exemplarily illustrate screenshots of a graphical user interface rendered on a rich communication services enabled user device.

FIG. 3D exemplarily illustrates a quick-response code corresponding to a person-to-application deep-link of a rich communication services (RCS) business messaging (RBM) agent.

FIG. 4 exemplarily illustrate screenshot of a graphical user interface rendered on an Android user device with a Messages client installed and the rich communication services is not enabled for the Messages client.

FIGS. 5A-5C exemplarily illustrate screenshots of a graphical user interface (GUI) rendered on an Android user device without a Messages client installed.

FIG. 6 exemplarily illustrates a screenshot of a graphical user interface rendered on a user device that does not support rich communication services.

FIG. 7A exemplarily illustrates a screenshot of a quick-response Code 600 corresponding to the uniform resource identifier link for the RBM Agent “Mobile Ecosystem Forum”.

FIG. 7B exemplarily illustrates a screenshot of an android user with rich communication services enabled messages application scanning the quick-response Code for the uniform resource identifier link.

FIG. 7C exemplarily illustrates a screenshot of an android user chatting with the RBM agent “Mobile Ecosystem Forum”.

FIG. 7D exemplarily illustrates a screenshot of a webpage displayed to an android user without messages application.

FIG. 7E exemplarily illustrates a screenshot of a web page displayed to an iPhone user without rich communication services.

FIG. 7F exemplarily illustrates a screenshot of a web page displayed to an iPhone user with rich communication services.

### DETAILED DESCRIPTION OF THE INVENTION

Various aspects of the disclosure herein are embodied as a system, a method, or a non-transitory, computer-readable storage medium having one or more computer readable program codes stored thereon. Accordingly, various embodiments of the disclosure herein take the form of an entirely hardware embodiment, an entirely software embodiment comprising, for example, microcode, firmware, software, etc., or an embodiment combining software and hardware aspects that are referred to herein as a “system”, a “module”, an “engine”, a “circuit”, or a “unit”.

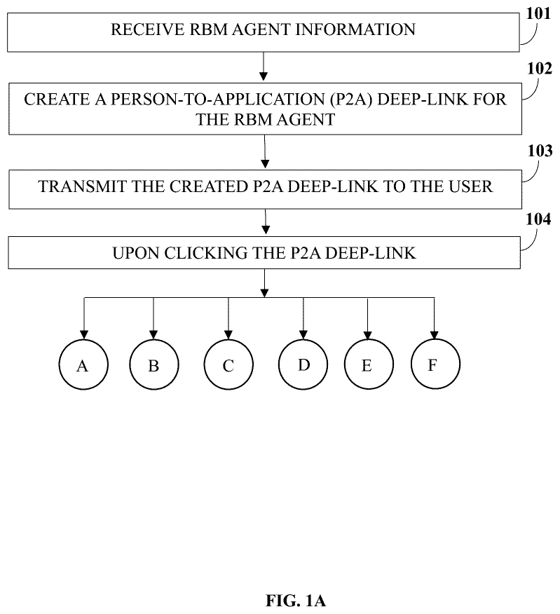

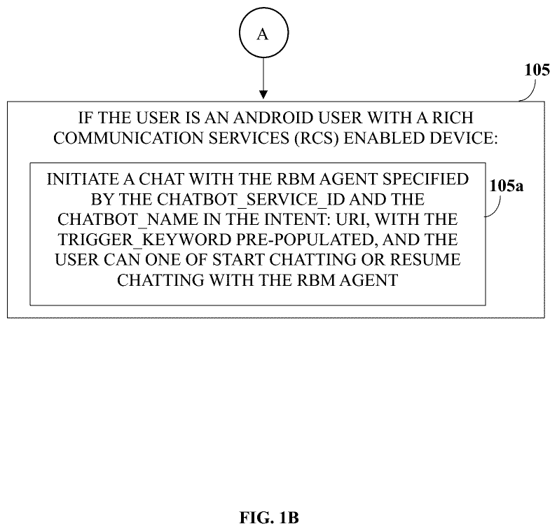

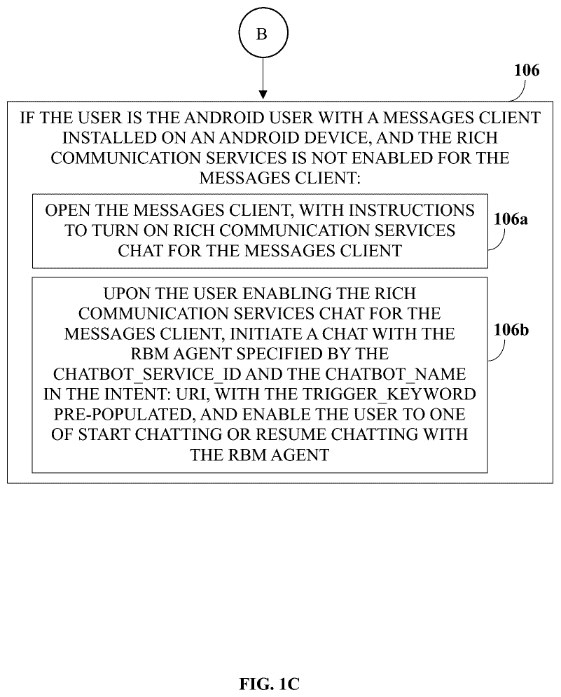

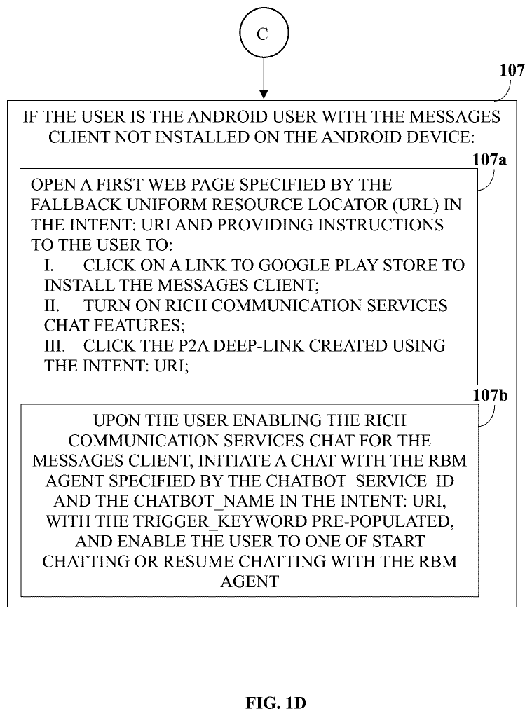

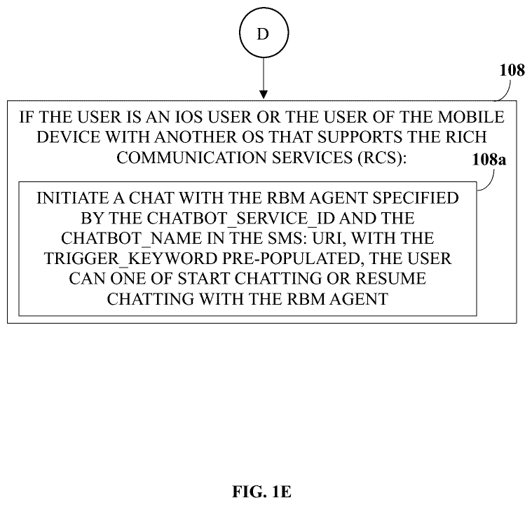

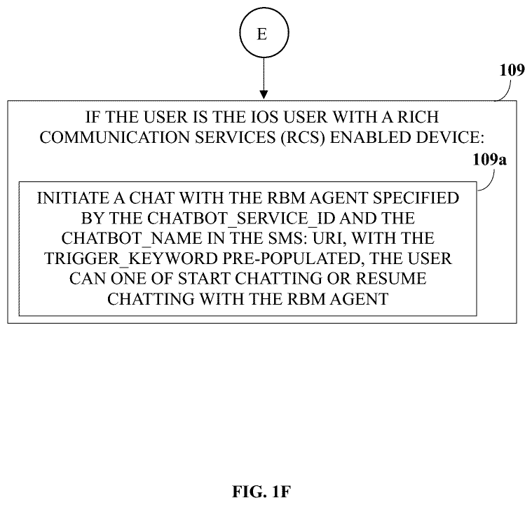

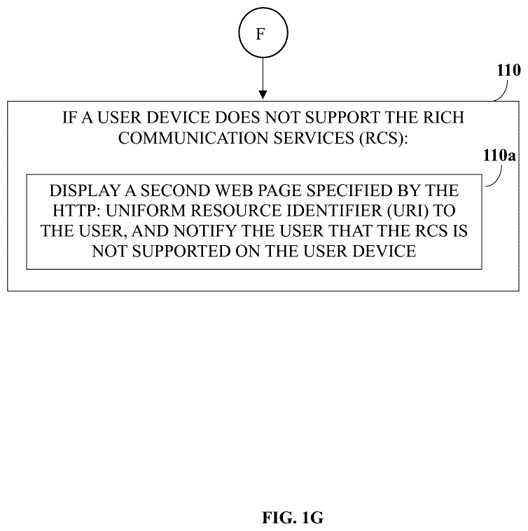

FIGS. 1A-1G illustrate flowcharts of a method for accessing a rich communication services (RCS) business messaging (RBM) agent. The method employs a rich communication services person-to-application (RCSP2A) executable by at least one processor configured to execute computer program instructions for creating a person-to-application (P2A) deep-link to access the RBM agent. In an embodiment, the RCSP2A is implemented as a cloud-based platform hosted on a server or a network of servers accessible via a network. In another embodiment, the RCSP2A is implemented in a cloud computing environment. As used herein, “cloud computing environment” refers to a processing environment comprising configurable, computing, physical, and logical resources, for example, networks, servers, storage media, virtual machines, applications, services, etc., and data distributed over a network, for example, the internet. The cloud computing environment is one of a private cloud, a public cloud, a hybrid cloud, etc. The cloud computing environment provides an on-demand network access to a shared pool of the configurable computing physical and logical resources. In an embodiment, the RCSP2A is a cloud computing-based platform implemented as a service for creating and transmitting a rich message. For example, the RCSP2A is configured as a software as a service (SaaS) platform, or a cloud-based software as a service (CSaaS) platform that creates and transmits a rich message. In another embodiment, the RCSP2A is implemented as a cloud platform service also known as platform as a service (PaaS). In another embodiment, the RCSP2A is implemented as an on-premise software installed and run on computers on the premises of an organization.

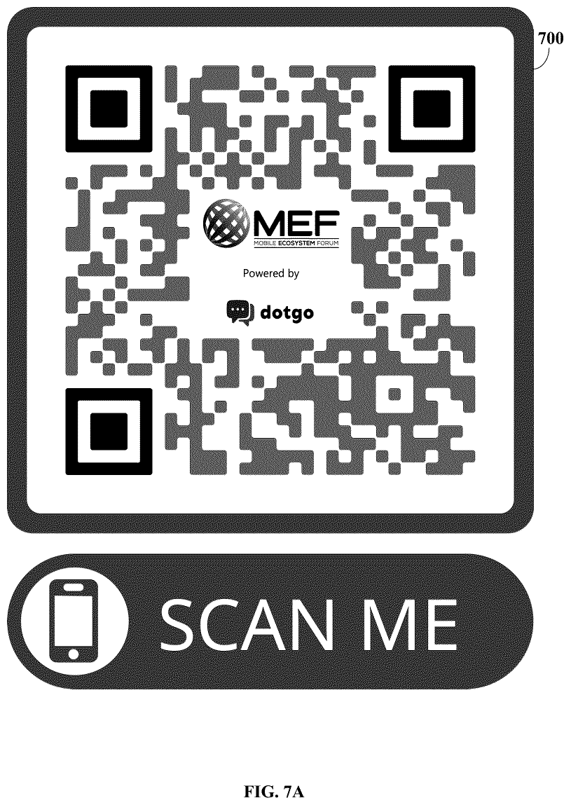

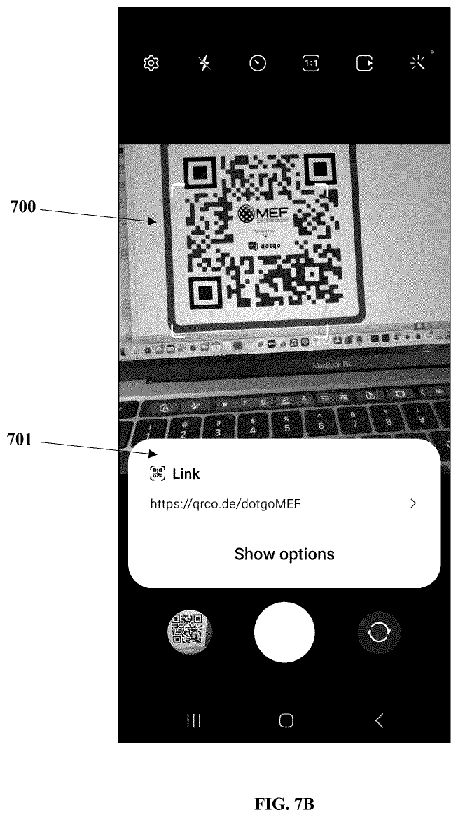

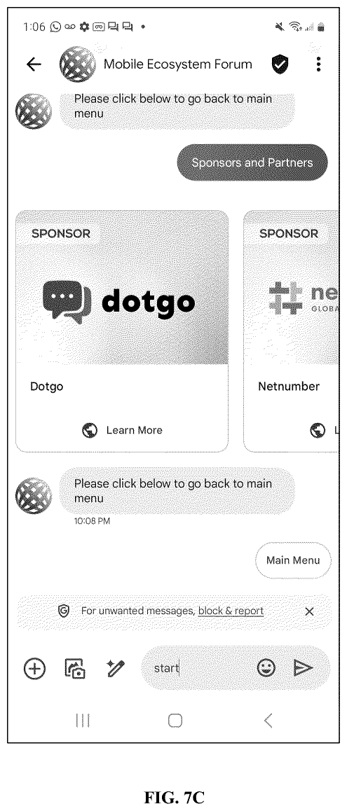

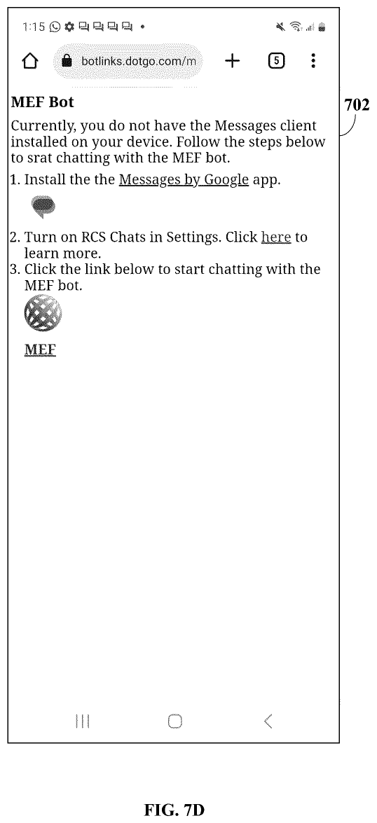

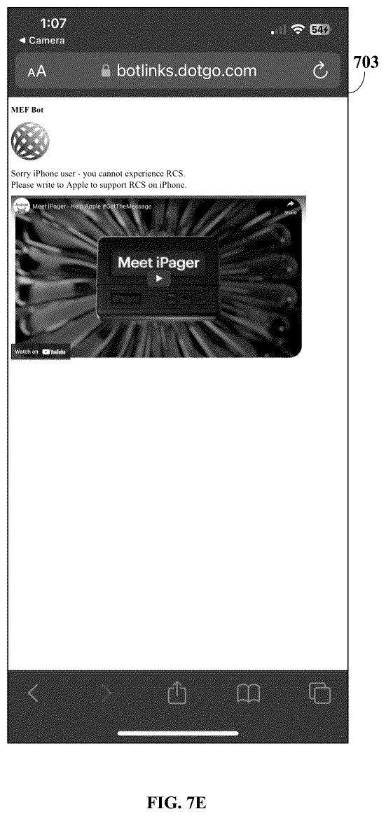

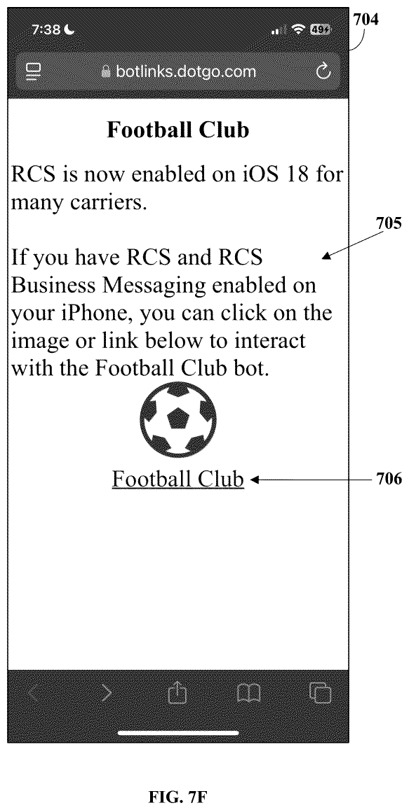

As illustrated in FIG. 1A, the rich communication services person-to-application (RCSP2A) receives 101 rich communication services (RCS) business messaging (RBM) agent information comprising a chatbot_service_id, a chatbot_name, and a trigger_keyword of the RBM agent, from a brand and/or developer. As used herein, the term “brand” refers to the name of an entity, a business, a company, an enterprise, an organization, etc., that sends a rich message or an equivalent rich message to a user device of the user. The brand is, for example, a for-profit business, a not-for-profit entity, a governmental entity, or a small business. Wherever reference is made to a brand taking or receiving an action, the reference refers to a developer or another person who takes or receives the action on behalf of the brand, or an application that takes or receives the action on behalf of the brand. The RCSP2A creates 102 a person-to-application (P2A) deep-link for the RBM agent using one of: a) an intent: uniform resource identifier (URI) along with a browser fallback uniform resource locator (URL) for an android user; b) an sms: URI for an iOS user or a user of a user device with another OS that supports the RCS; and c) an htttp: URI for the users on other devices that do not support the RCS. In an embodiment, the RCSP2A creates a P2A deep-link for the RBM agent using an URI based on the value of the chatbot_service_id and chatbot_name of the RBM Agent launched in different countries and carriers. In an embodiment, the RCSP2A creates a quick-response (QR) code corresponding to the P2A deep-link for the RBM agent, and users can scan the QR code to access the P2A deep-link to the RBM Agent, as exemplarily illustrated in FIG. 7A.

The P2A deep-link is provided as a service to brands and/or developers by an RCSP2A provider. In an embodiment, the RCSP2A provider is also a RBM platform provider for the brands and/or the developers to onboard and launch multiple RBM agents. The RCSP2A provider partners with one of Google Jibe, other messaging-as-a-platform, and a RBM platform to provide the P2A deep-link service for some or all of the multiple RBM agents launched on a partner platform. A carrier partners with the RCSP2A provider to offer the URI link service for the multiple RBM agents launched on a carrier's network. In an embodiment, the RCSP2A provider is also a RBM platform provider for the brands and/or the developers to onboard and launch the multiple RBM agents on the carrier's network. The carrier uses a different platform for onboarding and launching the multiple RBM agents on the carrier's network.

The RCSP2A transmits 103 the created P2A deep-link to a user. Upon the user clicking 104 the P2A deep-link, the users are redirected to different URIs based on their user device, country and carrier. The user device comprises Android, IOS, or other user devices. The RCSP2A provider collects, stores, and presents to brands, developers, carriers and other entities the information about the user's device along with additional information, such as country, carrier, location, internet protocol (IP) address, and locale of the user device for further processing and analysis. The RCSP2A uses the country and carrier of the user to determine the chatbot_service_id and chatbot_name of the RBM agent launched for the user in order to create the URIs to which the user is redirected to.

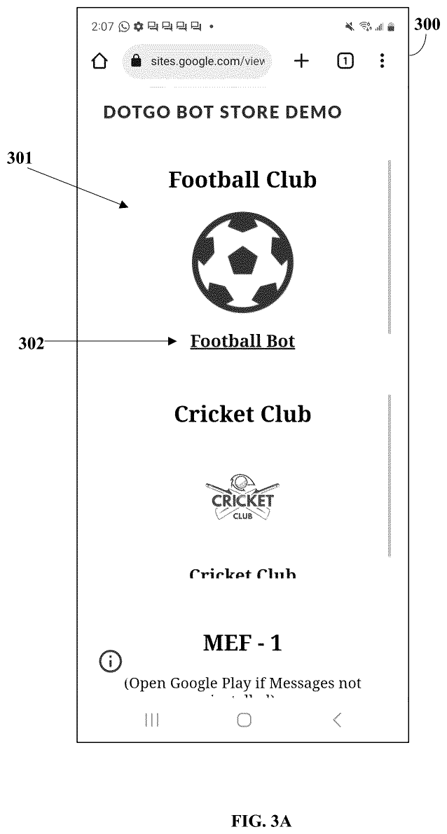

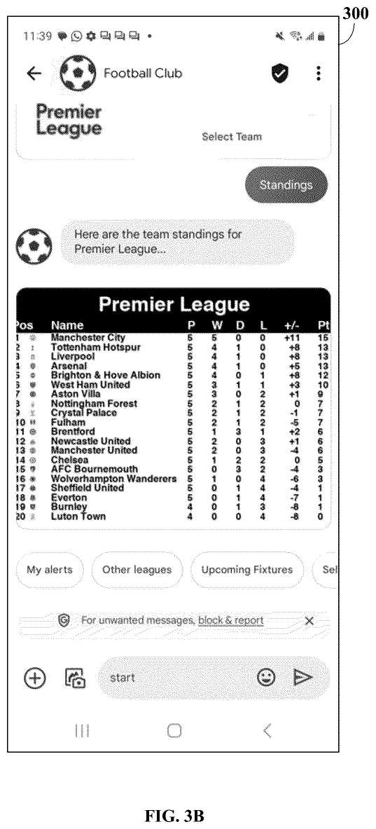

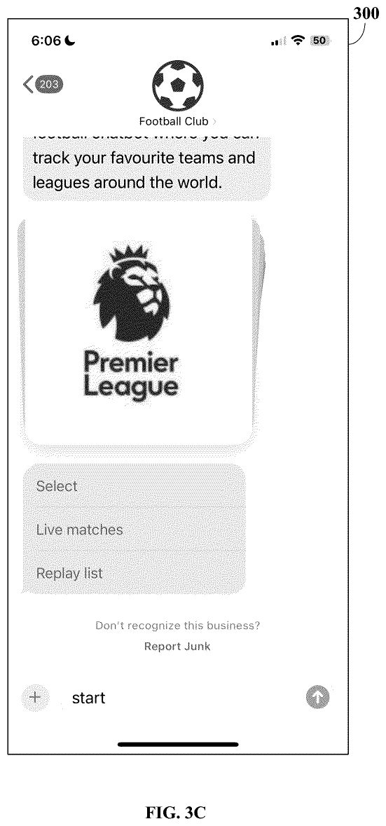

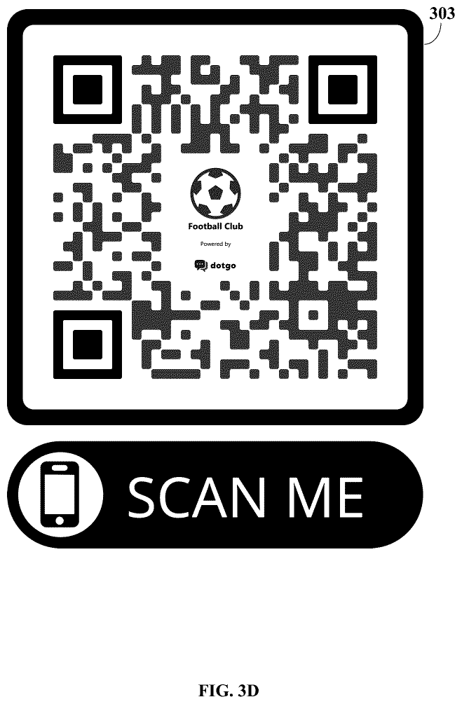

Upon the user clicking 104 the P2A deep-link, if the user is the Android user with a rich communication services (RCS) enabled device 105, the RCSP2A initiates 105a a chat with the RBM agent specified by the chatbot_service_id and the chatbot_name in the intent: URI, with the trigger_keyword pre-populated, as exemplarily illustrated in FIG. 3B. The user can one of start chatting with the RCS business messaging (RBM) agent or resume chatting with the RBM agent with which the user has previously exchanged messages, as exemplarily illustrated in FIG. 1B.

The uniform resource identifier (URI) used for Android users with the rich communication services (RCS) enabled device is of the form:
“intent: <chatbot_service_id>?bot-name=<chatbot_name>&body=<trigger_keyword> #Intent;scheme=sms;packag e=com.google.android.apps.messaging;S.browser_fallback_url=<alternative_web_page_with_instructions>;end”.

In an embodiment, a more reliable uniform resource identifier (URI) used for Android users with the rich communication services (RCS) enabled device is of the form:
“intent: <chatbot service_id>?bot-name=<chatbot_name>&body=<trigger_keyword> #Intent;scheme=rcs;package-com.google.android.apps.messaging;S.browser_fallback_url=<alternative_web page_with_instructions>;end”

The person-to-application (P2A) deep-link is provided as a service to brands and/or developers by a rich communication services person-to-application (RCSP2A) provider. In an embodiment, the RCSP2A provider is also the RBM platform provider for brands and/or developers to onboard and launch RBM agents. A carrier partners with RCSP2A provider to offer the P2A deep-link service for RBM agents launched on the carrier's network. The RCSP2A provider is also the RBM platform provider for brands and/or developers to onboard and launch the RBM agent on the carrier's network. In an other embodiment, the carrier uses a different platform for onboarding and launch of the RBM agent on their network. In yet another embodiment, the RCSP2A provider partners with Google Jibe, or another MaaP or RBM platform to provide the P2A deep-link service for some or all of the multiple RBM agents launched on their platform or a partner platform.

Upon clicking 104 the P2A deep-link, if the user is the Android user with a messages client installed on an Android device and the rich communication services (RCS) is not enabled for the messages client 106, the RCSP2A opens 106a the messages client, with instructions to turn on RCS chat for the messages client, as exemplarily illustrated in FIG. 1C. Upon the user enabling the RCS chat for the messages client, the RCSP2A initiates 106b a chat with the RBM agent specified by the chatbot_service_id and the chatbot_name in the intent: URI, with the trigger_keyword pre-populated, and enabling the user to one of start chatting with the RBM agent or resume chatting with the RBM agent with which the user has previously exchanged messages, as exemplarily illustrated in FIG. 3B.

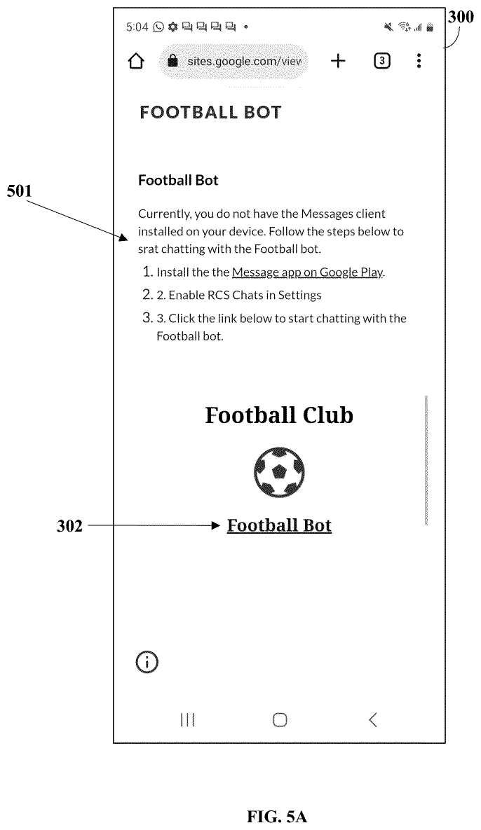

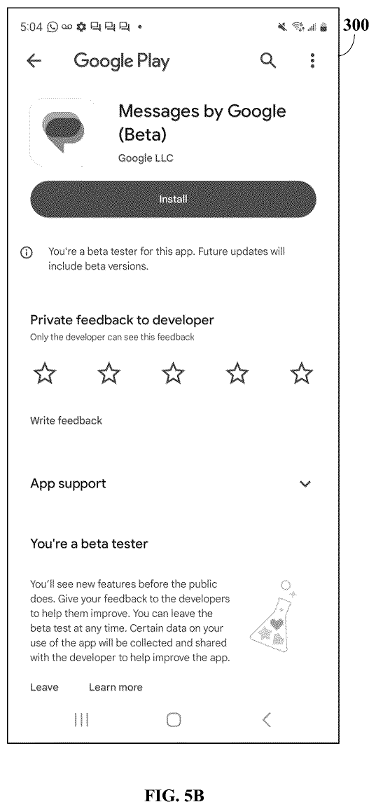

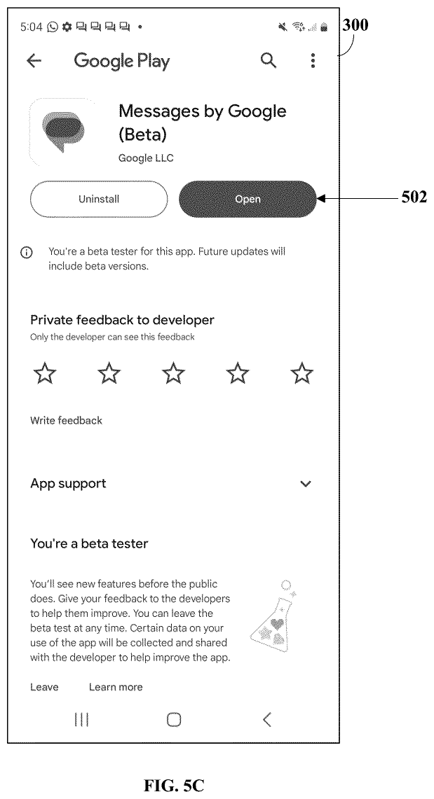

Upon clicking 104 the P2A deep-link, if the user is the Android user with the messages client not installed on the Android device, the RCSP2A opens 107a a first web page i.e., “alternative_web_page_with_instructions”, as specified by the fallback uniform resource locator (URL) in the intent: URI and, as exemplarily illustrated in FIG. 5A. The first web page i.e., “alternative_web_page_with_instructions”, contains instructions to the user to:
(i) click on a link to Google Play store to install the messages client;
(ii) turn on rich communication services (RCS) chat features; and
(iii) click the P2A deep-link created using the intent: URI.

Upon the user enabling the rich communication services chat for the messages client, the RCSP2A initiates 107b a chat with the RBM Agent specified by the chatbot_service_id and the chatbot_name in the intent: URI, with the trigger_keyword pre-populated, and enables the user to one of start chatting with the RBM agent or resume chatting with the RBM agent with which the user has previously exchanged messages, as exemplarily illustrated in FIG. 1D.

Upon clicking 104 the P2A deep-link, if the user is the iPhone operation system (iOS) user or the user of the user device with other operation system (OS) that supports the rich communication services (RCS), the RCSP2A initiates 108 a chat with the RBM agent specified by the chatbot_service_id and the chatbot_name in the sms: URI, with the trigger_keyword pre-populated, as exemplarily illustrated in FIG. 1E. The uniform resource identifier (URI) used for the iOS users and the users of user devices with other OS that support RCS is of the form: “sms: <chatbot_service_id>?bot-name=<chatbot_name>&body=<trigger_keyword>”. The user can one of start chatting with the RBM agent or resume chatting with the RBM agent with which the user has previously exchanged messages. In an embodiment, the URI used for the iOS users is of the form: “imessage:<chatbot_service_id>?bot-name=<chatbot_name>&body=<trigger_keyword>”. In another embodiment, the URI used for the iOS users and the users of user devices with other OS that support RCS is of the form: “smsto: <chatbot_service_id>?bot-name=<chatbot_name>&body=<trigger_keyword>”.

Upon the user clicking 104 the P2A deep-link, if the user is the iOS user with a rich communication services (RCS) enabled device 109, the RCSP2A initiates 109a a chat with the RBM agent specified by the chatbot_service_id and the chatbot_name in the sms: URI, with the trigger_keyword pre-populated, as exemplarily illustrated in FIG. 3C. The user can one of start chatting with the RCS business messaging (RBM) agent or resume chatting with the RBM agent with which the user has previously exchanged messages, as exemplarily illustrated in FIG. 1F.

In an embodiment, upon the iOS user clicking the P2A deep-link, a web page with a message “RCS is now enabled on iOS 18 for many carriers. If you have RCS and RCS Business Messaging enabled on your iPhone, you can click on the image or link below to interact with the Football Club bot.” is displayed on the user's iPhone, as exemplarily illustrated in FIG. 7F. Upon the iOS user clicking on the image 705 or P2A link 706, as exemplarily illustrated in FIG. 7F, if the iOS user has a rich communication services (RCS) enabled device, the RCSP2A initiates a chat with the RBM agent specified by the chatbot_service_id and the chatbot_name in the sms: URI, with the trigger_keyword pre-populated, as exemplarily illustrated in FIG. 3C. The user can one of start chatting with the RCS business messaging (RBM) agent or resume chatting with the RBM agent with which the user has previously exchanged messages.

Upon clicking 104 the P2A deep-link, if a user device does not support rich communication services (RCS), the RCSP2A displays 110a a web page specified by the tag S.browser_fallback_url=<value> to the user, and notifies the user that the RCS is not supported on the user device, as exemplarily illustrated in FIG. 1G. The URI used for the users on other user devices that do not support RCS is of the form: “http://<alternative_web_page_with_instructions>”.

In another embodiment, the uniform resource identifier (URI) used for all users, including users with Android device, iOS device, and devices with other OS is of the form: “rcs:<chatbot_service_id>?bot-name=<chatbot_name>&body=<trigger_keyword>&fall_back_URL=<web_page_for_non_RCS_users>”. Upon the user clicking the P2A deep-link, if the user has a rich communication service (RCS) enabled device, the RCSP2A initiates a chat with the RBM agent specified by the chatbot_service_id and the chatbot_name in the rcs: URI, with the trigger_keyword pre-populated. The user can start chatting with the RBM agent or resume chatting with the RBM agent with which the user has previously exchanged messages. Upon the user clicking the P2A deep-link, if the user does not have a RCS enabled device, the user is taken to the <web_page_for_non_RCS_users> as specified in the fall_back_URL tag of the rcs: URI.

In another embodiment, the method for supporting person-to-application (P2A) deep-link involves adding support for ‘rcs:’ scheme by messaging apps. Currently, Messages client and other RCS capable clients support ‘sms:’, ‘smsto:’, ‘mms:’, and ‘mmsto:’ schemes for RCS sender identifiers (IDs). However, since these schemes are also supported by other SMS clients that are not capable of supporting RCS, it leads to an ‘sms: URI’ to be opened by a non RCS enabled client as well. By supporting the ‘rcs:’ scheme, the RCS capable clients such as, Messages from Google and Samsung Messages, can ensure that the ‘rcs:’ scheme is recognized only if an RCS capable client is installed and enabled on the user's device. With the support for ‘rcs:’ as the scheme, the URL can be updated as: <a href=\“intent: dotgo-football-club@rbm.goog?botname=Football+Club&body=start #Intent;scheme=rcs;package=c om.google.android.apps.messaging;S.browser_fallback_url=https%3A%2F%2Fsites. google.com%2Fview%2FFootballbot%2Fhome;end\”>Football Bot</a>

In another embodiment, a method for accessing one or more rich communication services (RCS) business messaging (RBM) agents launched with multiple chatbot_service_id's in multiple countries and/or carriers is provided. The rich communication services person-to-application (RCSP2A) receives rich communication services (RCS) business messaging (RBM) agent information comprising chatbot_service_id's of multiple RBM agents launched in multiple countries and/or carriers, chatbot_name's of each of the corresponding multiple RBM agents launched in multiple countries and/or carriers, and a trigger_keyword of the RBM agent, from a brand and/or developer. The RCSP2A creates a common person-to-application (P2A) deep-link for the multiple RBM agents launched in multiple countries and/or carriers. The common P2A deep-link works for users in these countries and/or carriers. Upon a user clicking the common P2A deep-link, the RCSP2A determines the country, the carrier, type of user device, other information of the user, etc. Based on the collected information, the RCSP2A generates a uniform resource identifier (URI) for the user, and redirects the user to the generated URI in order to initiate a chat with a RBM agent specific to the user's country and/or carrier.

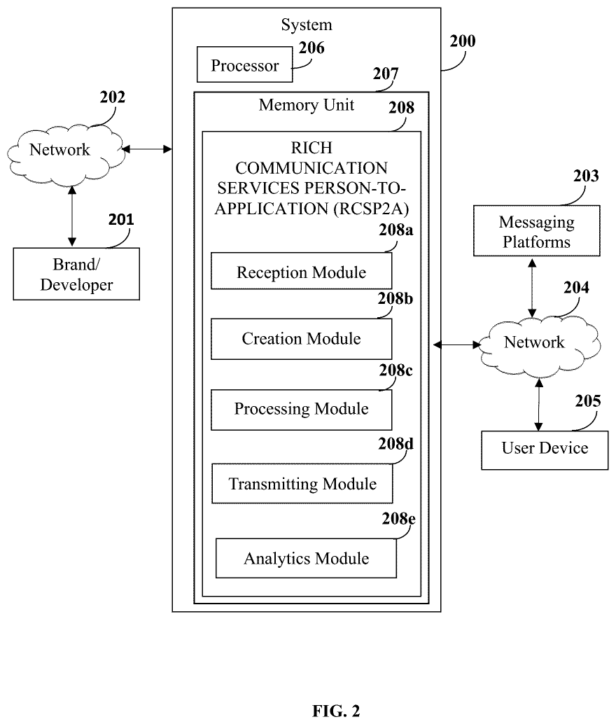

FIG. 2 exemplarily illustrates an architectural block diagram of an exemplary implementation of a system 200 for accessing a rich communication services (RCS) Business Messaging (RBM) agent. The system 200 disclosed herein is a computer system programmable using high-level computer programming languages. The system 200 is accessible to a brand or a developer 201 on behalf of the brand via a network 202 through a broad spectrum of technologies and devices such as personal computers with access to the internet, laptops, mobile computing devices, smart phones, tablet computing devices, servers, workstations, a portable electronic device, a network-enabled computing device, an interactive network-enabled communication device, any other suitable computing equipment, combinations of multiple pieces of computing equipment, etc. Furthermore, the system 200 communicates with multiple messaging platforms 203 that host rich messaging channels, via a network 204. The messaging platforms 203 comprise, for example, Google Business Messages (GBM), WhatsApp®, Rich Communication Services (RCS), iMessage®, Viber®, Facebook® Messenger, etc. Furthermore, the messaging platforms 203 are accessible to a user device 205 of a user via a network 204. The user device 205 is an electronic device, for example, one or more of a personal computer, a tablet computing device, a mobile computer, a mobile phone, a smartphone, a portable computing device, a laptop, a personal digital assistant, a wearable computing device such as smart glasses, a smart watch, etc., a touch centric device, a workstation, a client device, a portable electronic device, a network-enabled computing device, an interactive network-enabled communication device, an image capture device, any other suitable computing equipment, combinations of multiple pieces of computing equipment, etc.

An operating system, for example, on the Android® platform of Google Inc., the iOS platform of Apple Inc., the Windows® platform of Microsoft Corporation, or other platforms run the user device 205. The user device 205 is configured to receive messages, for example, rich messages, short message service (SMS) messages, etc., via the network 204. The networks 202 and 204 that connect the system 200 to the brand 201, the messaging platforms 203, and the user device 205, respectively, are each, for example, one of the internet, satellite internet, a wireless network, a network that implements Wi-Fi® of Wi-Fi Alliance Corporation, an ultra-wideband (UWB) communication network, a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a fifth generation (5G) mobile communication network, a long-term evolution (LTE) mobile communication network, a public telephone network, etc., a local area network, a wide area network, an internet connection network, an infrared communication network, etc., or a network formed from any combination of these networks.

The system 200 disclosed herein interfaces with the devices of the brand or developer 201 on behalf of the brand and the messaging platforms 203, and in turn, with the user device 205, and in an embodiment, with one or more database systems (not shown) and servers (not shown) to implement the rich communication services person-to-application (RCSP2A) service, and therefore more than one specifically programmed computing system is used for implementing the rich communication services person-to-application (RCSP2A) service. As exemplarily illustrated in FIG. 2, the system 200 comprises at least one processor 206, and a non-transitory, computer readable storage medium, for example, a memory unit 207. As used herein, “non-transitory, computer-readable storage medium” refers to all computer readable media that contain and store computer programs and data. Examples of the computer-readable media comprise hard drives, solid state drives, optical discs or magnetic disks, memory chips, a read-only memory (ROM), a register memory, a processor cache, a random-access memory (RAM), etc. The system 200 further comprises the rich communication services person-to-application (RCSP2A) 208 configured to define computer program instructions executable by at least one processor 206. The non-transitory, computer readable storage medium, herein exemplarily referred to as the memory unit 207, is configured to store the computer program instructions defined by the RCSP2A 208. In an embodiment, the memory unit 207 stores the modules 208a, 208b, 208c, 208d and 208e of the RCSP2A 208 as exemplarily illustrated in FIG. 2.

The processor 206 is operably and communicatively coupled to the memory unit 207 for executing the computer program instructions defined by the modules, for example, 208a, 208b, 208c, 208d and 208e of the rich communication services person-to-application (RCSP2A) 208. The memory unit 207 is a storage unit used for recording, storing, and reproducing data, program instructions, and applications. In an embodiment, the memory unit 207 comprises a random-access memory (RAM) or another type of dynamic storage device that serves as a read and write internal memory and provides short-term or temporary storage for information and instructions executable by the processor 206. The memory unit 207 also stores temporary variables and other intermediate information used during execution of the instructions by the processor 206. In another embodiment, the memory unit 207 further comprises a read-only memory (ROM) or another type of static storage device that stores firmware, static information, and instructions for execution by the processor 206. The modules, for example, 208a, 208b, 208c, 208d and 208e of the RCSP2A 208, when loaded into the memory unit 207 and executed by the processor 206, transform the system 200 into a specially-programmed, special purpose computing device configured to implement the functionality disclosed herein. The processor 206 refers to one or more microprocessors, central processing unit (CPU) devices, finite state machines, computers, microcontrollers, digital signal processors, logic, a logic device, an application specific integrated circuit (ASIC), a field-programmable gate array (FPGA), a chip, etc., or any combination thereof, capable of executing computer programs or a series of commands, instructions, or state transitions. In an embodiment, the processor 206 is implemented as a processor set comprising, for example, a programmed microprocessor and a math or graphics co-processor. The RCSP2A 208 is not limited to employing the processor 206. In an embodiment, the RCSP2A 208 employs a controller or a microcontroller.

The rich communication services person-to-application (RCSP2A) 208 defines computer program instructions, which when executed by the processor 206, causes the processor 206 to manage actions associated with creating and transmitting the person-to-application (P2A) deep-link, and accessing the rich communication services (RCS) Business Messaging (RBM) agent. In the exemplary implementation of the system 200 illustrated in FIG. 2, the RCSP2A 208 comprises a reception module 208a, a creation module 208b, a processing module 208c, a transmitting module 208c, and an analytics module 208e. The reception module 208a is configured to receive rich communication services (RCS) business messaging (RBM) agent information from the brand and/or developer 201 on behalf of the brand. The received RBM Agent information comprises a chatbot_service_id, a chatbot_name, and a trigger_keyword of the RBM agent channel. In an embodiment, the received RBM agent information comprises chatbot_service_id and chatbot_name for different countries and carriers.

The creation module 208b is configured to create a person-to-application (P2A) deep-link for the RBM agent. The creation module 208b creates the P2A deep-link using one of: a) an intent: uniform resource identifier (URI) along with a browser fallback uniform resource locator (URL) for an android user; b) an sms: URI for an iOS user or a user of a user device with other OS that supports the rich communication services (RCS); and c) an htttp: URI for the users on other devices that do not support the RCS. In an embodiment, the RCSP2A 208 creates a quick-response (QR) code (QR Code) corresponding to the P2A deep-link for the RBM agent. The user can scan the QR Code using the user device 205 to access the P2A deep-link to the RBM agent. The reception module 208a is further configured to receive a request, from the brand and/or developer 201, to send the created P2A deep-link to the user. The transmitting module 208d is configured to transmit the created P2A deep-link to the user. The user receives the P2A deep-link to the user device 205.

The P2A deep-link is provided as a service to brands and/or developers 201 by an RCSP2A provider. In an embodiment, the RCSP2A provider is also a RBM platform provider for the brands and/or the developers 201 to onboard and launch multiple RBM agents. A carrier partners with the RCSP2A provider to offer the URI link service for the multiple RBM agents launched on a carrier's network. In another embodiment, the RCSP2A provider is also a RBM platform provider for the brands and/or the developers to onboard and launch the multiple RBM agents on the carrier's network. The carrier uses a different platform for onboarding and launching the multiple RBM agents on the carrier's network. In another embodiment, the RCSP2A provider partners with one of Google Jibe, another messaging-as-a-platform, and a RBM platform to provide the P2A deep-link service for some or all of the multiple RBM agents launched on a partner platform.

Upon the user clicking the P2A deep-link, the processing module 208c is configured to process the request from the user and determines user device and redirects the user to different URIs based on their user device comprising Android, IOS, or other mobile devices. The processing module 208c is further configured to collect information about the user device and location of the user, and save the collected information in a database (not shown) for further analysis. If the user is the android user with a rich communication services (RCS) enabled device, the processing module is configured to redirect the user to the URI for android users. The URI used for the android users is of the form: “intent: <chatbot_service_id>?bot-name=<chatbot_name>&body=<trigger_keyword> #Intent;scheme=sms;package=co m.google.android.apps.messaging;S.browser_fallback_url=<first_web_page>; end”. Clicking on the intent: URI, initiates a chat with the RBM Agent specified by the chatbot_service_id and the chatbot_name in the intent: URI, with the trigger_keyword pre-populated. The user can one of start chatting with the RBM agent or resume chatting with the RBM agent with which the user has previously exchanged messages.

In an embodiment, the processing module 208c is further configured to collect information about the user's device and other information such as country, carrier, location, internet protocol (IP) address, and locale of the user device, and save the collected information for further processing and analysis. Furthermore, the collected information is presented by the RCSP2A provider to the brands, developers, carriers and other entities. The processing module 208c uses the country and carrier of the user to determine the chatbot_service_id and chatbot_name of the RBM agent launched for the user in order to create the URIs to which the user is redirected to.

Upon the user clicking the P2A deep-link, if the user is the android user with a messages client installed on an android device, and the rich communication services is not enabled for the messages client, the processing module 208c is configured to redirect the user to the URI for android users. The URI used for the android users is of the form: “intent: <chatbot_service_id>?bot-name=<chatbot_name>&body=<trigger_keyword> #Intent;scheme=sms;package=co m.google.android.apps.messaging;S.browser_fallback_url=<first_web_page>; end”. Clicking on the intent: URI opens the messages client on the user device 205, with instructions to turn on rich communication services (RCS) chat for the messages client. Upon the user enabling the RCS chat for the messages client, the intent: URI initiates a chat with the RBM Agent specified by the chatbot_service_id and the chatbot_name in the intent: URI, with the trigger_keyword pre-populated, and enables the user to one of start chatting with the RBM agent or resume chatting with the RBM agent with which the user has previously exchanged messages.

Upon the user clicking the P2A deep-link, if the user is the android user with the messages client not installed on the android device, the processing module 208c is configured to redirect the user to the URI for android users. The URI used for the android users is of the form: “intent: <chatbot_service_id>?bot-name=<chatbot_name>&body=<trigger_keyword> #Intent;scheme=sms;package=co m.google.android.apps.messaging;S.browser_fallback_url=<first_web_page>;end”. Clicking on the intent: URI opens a first web page i.e., “alternative_web_page_with_instructions”, on the user device 205, specified by the fallback uniform resource locator (URL) in the intent: URI and provides instructions to the user to: i) click on a link to Google Play store to install the messages client; ii) turn on rich communication services chat features; iii) click the P2A deep-link created using the intent: URI. Upon the user enabling the rich communication services chat for the messages client, the intent: URI initiates a chat with the RBM Agent specified by the chatbot_service_id and the chatbot_name in the intent: URI, with the trigger_keyword pre-populated, and enables the user to one of start chatting with the RBM agent or resume chatting with the RBM agent with which the user has previously exchanged messages.

Upon the user clicking the P2A deep-link, if the user is the iPhone operating system (iOS) user, or the user of the user device with other operating system (OS) that supports the rich communication services (RCS), the processing module 208c is configured to redirect the user to the URI for iOS users. The URI used for the iOS users and the users of the mobile device with other OS that supports RCS is of the form: “sms: <chatbot service_id>?bot-name=<chatbot_name>&body=<trigger_keyword>”. Clicking on the sms: URI initiates a chat with the RBM Agent specified by the chatbot_service_id and the chatbot_name in the sms: URI, with the trigger_keyword pre-populated. The user can one of start chatting with the RBM agent or resume chatting with the RBM agent with which the user has previously exchanged messages.

Upon the user clicking the P2A deep-link, if a user device does not support the rich communication services (RCS), the processing module 208c is configured to redirect the user to the URI for devices with no support for RCS. The URI used for the users on other devices that do not support RCS is of the form: “http://<second_web_page>”. Clicking on the http: URI displays a second web page specified by the http: uniform resource identifier (URI) to the user on the user device 205, and notifies the user that RCS is not supported on the user device 205.

The analytics module 208e is configured to analyze user data related to users clicking on the P2A deep-link, which is collected and stored in the database (not shown) by the processing module 208c. The analytics module 208e is further configured to generate analytics related to the user data and presents it to brands.

The processor 206 of the system 200 disclosed herein retrieves instructions defined by the reception module 208a, the creation module 208b, the processing module 208c, the transmitting module 208d, the analytics module 208e, etc., from the memory unit 207 for executing their respective functions disclosed above. The modules 208a, 208b, 208c, 208d and 208e of the rich communication services person-to-application (RCSP2A) 208 are disclosed above as software executed by the processor 206. In an embodiment, the modules 208a, 208b, 208c, 208d and 208e of the RCSP2A 208 are implemented in hardware. In another embodiment, the modules 208a, 208b, 208c, 208d and 208e of the RCSP2A 208 are implemented by logic circuits to carry out their respective functions disclosed above. In another embodiment, the system 200 is also implemented as a combination of hardware and software including the application programming interface (API) and one or more processors, for example, 206, that are used to implement the modules, for example, 208a, 208b, 208c, 208d and 208e of the RCSP2A 208.

For purposes of illustration, the disclosure herein refers to the modules 208a, 208b, 208c, 208d and 208e of the rich communication services person-to-application (RCSP2A) 208 being run locally on a single computer system 200; however the scope of the RCSP2A 208 and the method disclosed herein is not limited to the modules 208a, 208b, 208c, 208d and 208e being run locally on a single computer system 200 via an operating system and the processor 206, but extends to running the modules 208a, 208b, 208c, 208d and 208e remotely over the network 204 by employing a web browser and a remote server, a mobile phone, or other electronic devices. In an embodiment, one or more portions of the system 200 disclosed herein are distributed across one or more computer systems (not shown) coupled to the network 204.

The non-transitory, computer-readable storage medium, herein exemplarily referred to as the memory unit 207, stores computer program instructions of the rich communication services person-to-application (RCSP2A) 208 executable by at least one processor 206 for managing actions associated with creating and transmitting the person-to-application (P2A) deep-link, and accessing the rich communication services (RCS) Business Messaging (RBM) agent. The computer program instructions when executed by the processor 206 cause the processor 206 to: receive RBM agent information, wherein the received RBM agent information comprises a chatbot_service_id, a chatbot_name, and a trigger_keyword of the RBM agent; create a P2A deep-link for the RBM agent, wherein the P2A deep-link is created using one of: a) an intent: uniform resource identifier (URI) along with a browser fallback uniform resource locator (URL) for an android user; b) an sms: URI for an iOS user or a user of a mobile device with another OS that supports the rich communication services (RCS); and c) an htttp: URI for the users on other devices that do not support the RCS; transmit the created P2A deep-link to the user; upon clicking, by the user, the P2A deep-link: (a) if the user is the android user with a RCS enabled device: initiate a chat with the RBM Agent specified by the chatbot_service_id and the chatbot_name in the intent: URI, with the trigger_keyword pre-populated, wherein the user can one of start chatting with the RBM agent or resume chatting with the RBM agent with which the user has previously exchanged messages; (b) if the user is the android user with a messages client installed on an android device, wherein the rich communication services is not enabled for the messages client: open the messages client, with instructions to turn on rich communication services chat for the messages client; and upon the user enabling the rich communication services chat for the messages client, initiate a chat with the RBM Agent specified by the chatbot_service_id and the chatbot_name in the intent: URI, with the trigger_keyword pre-populated, and enable the user to one of start chatting with the RBM agent or resume chatting with the RBM agent with which the user has previously exchanged messages; (c) if the user is the android user with the messages client not installed on the android device: open a first web page i.e., “alternative_web_page_with_instructions”, specified by the fallback URL in the intent: URI and provide instructions to the user to: (i) click on a link to Google Play store to install the messages client; (ii) turn on rich communication services chat features; (iii) click the P2A deep-link created using the intent: URI; upon the user enabling the rich communication services chat for the messages client, initiate a chat with the RBM Agent specified by the chatbot_service_id and the chatbot_name in the intent: URI, with the trigger_keyword pre-populated, and enable the user to one of start chatting with the RBM agent or resume chatting with the RBM agent with which the user has previously exchanged messages; (d) if the user is the iOS user or the user of the mobile device with another OS that supports the RCS: initiate a chat with the RBM Agent specified by the chatbot_service_id and the chatbot_name in the sms: URI, with the trigger_keyword pre-populated, wherein the user can one of start chatting with the RBM agent or resume chatting with the RBM agent with which the user has previously exchanged messages; and (e) if a user device does not support the RCS: display a second web page specified by the http: URI to the user, and notify the user that the RCS is not supported on the user device.

The computer program instructions disclosed above implement the processes of various embodiments disclosed above and perform additional steps that may be required and contemplated for managing actions associated with creating and transmitting the person-to-application (P2A) deep-link, and accessing the rich communication services (RCS) Business Messaging (RBM) agent. When the computer program instructions are executed by the processor(s) 206, the computer program instructions cause the processor(s) 206 to perform the steps of the method for creating and transmitting a rich message as disclosed in the descriptions of FIGS. 1-2. In an embodiment, a single piece of computer program code comprising computer program instructions performs one or more steps of the method disclosed in the descriptions of FIGS. 1-2. The processor(s) 206 retrieves these computer program instructions and executes them.

A module, or an engine, or a unit, as used herein, refers to any combination of hardware, software, and/or firmware. As an example, a module, or an engine, or a unit includes hardware such as a microcontroller, associated with a non-transitory, computer readable storage medium to store computer program codes adapted to be executed by the microcontroller. Therefore, references to a module, or an engine, or a unit, in an embodiment, refer to the hardware that is specifically configured to recognize and/or execute the computer program codes to be held on a non-transitory, computer-readable storage medium. In an embodiment, the computer program codes comprising computer readable and executable instructions are implemented in any programming language, for example, C, C++, C#, Java®, JavaScript®, Fortran, Ruby, Perl®, Python®, Visual Basic®, hypertext pre-processor (PHP), Microsoft®.NET, Objective-C®, the Swift™ programming language of Apple Inc., etc. In another embodiment, other object-oriented, functional, scripting, and/or logical programming languages are also used. In an embodiment, the computer program codes or software programs are stored on or in one or more mediums as object code. In another embodiment, the term “module” or “engine” or “unit” refers to the combination of the microcontroller and the non-transitory, computer-readable storage medium. Often module or engine or unit boundaries that are illustrated as separate commonly vary and potentially overlap. For example, a module or an engine or a unit may share hardware, software, firmware, or a combination thereof, while potentially retaining some independent hardware, software, or firmware. In various embodiments, a module or an engine or a unit includes any suitable logic.

FIGS. 3A-3C exemplarily illustrates screenshots of a graphical user interface (GUI) 300 rendered on a rich communication services (RCS) enabled user device. Consider an example where the rich communication services person-to-application (RCSP2A) 208 receives RBM Agent information comprising a chatbot_service_id, a chatbot_name, and a trigger_keyword of the RBM Agent from a brand and/or developer 201. The RCSP2A 208 creates a person-to-application (P2A) deep-link 302 for the RBM agent on a webpage 301 for the RBM agent, as exemplarily illustrated in FIG. 3A. In an embodiment, the RCSP2A creates a quick-response (QR) code 303 corresponding to the P2A deep-link for the RBM agent, as exemplarily illustrated in FIG. 3D. Upon a user scanning the QR code, P2A deep-link 302 of the RBM Agent is rendered to the user. Upon the user clicking the P2A deep-link 302, if the user is the android user with a rich communication services (RCS) enabled device, the RCSP2A 208 initiates a chat with the RBM Agent specified by the chatbot_service_id and the chatbot_name in the intent: URI, with the trigger_keyword pre-populated, as exemplarily illustrated in FIG. 3B. Upon the user clicking the P2A deep-link 302, if the user is the iOS user with a rich communication services (RCS) enabled device 109, the RCSP2A 208 initiates a chat with the RBM agent specified by the chatbot_service_id and the chatbot_name in the sms: URI, with the trigger_keyword pre-populated, as exemplarily illustrated in FIG. 3C. The user can start chatting with the rich communication services (RCS) business messaging (RBM) agent, or resume chatting with the RBM agent with which the user has previously exchanged messages.

For example, the following are the values of the different URI's to which the user is redirected depending on their country, carrier and type of user device:
(a) URI for Android users in Brazil is of the form: “intent: dotgo-football-club-brazil@rbm.goog?bot-name=Football+Club&body=Hi#Intent;package=com.google.android.apps.messaging; scheme=sms;S.browser_fallback_url=https%3A%2F%2Fbotlinks.dotgo.com %2Ffoot ball_club_android_no_rcs_brazil.html%0A;end”;
(b) URI for iphone users in Brazil is “sms: dotgo-football-club-brazil@rbm.goog?bot-name=Football+Club&body=Hi” (c) URI for users of a user device with other operating system in Brazil is of the form: “https://botlinks.dotgo.com/football_club_others_brazil.html”
(d) URI for Android users in India is of the form: “intent: dotgo-football-club-india@rbm.goog?bot-name=Football+Club&body=Hi #Intent;package=com.google.android.apps.messaging; scheme=sms;S.browser_fallback_url=https%3A%2F%2Fbotlinks.dotgo.com%2Ffoot ball_club_android_no_rcs_india.html%0A;end”
(e) URI for iphone users in India is of the form: “sms: dotgo-football-club-india@rbm.goog?bot-name=Football+Club&body=Hi”
(f) URI for users of a user device with other operating system in India is of the form: “https://botlinks.dotgo.com/football_club_others_india.html”
(g) URI for Android users in rest of world is of the form: “intent: dotgo-football-club@rbm.goog?bot-name=Football+Club&body=Hi #Intent;package=com.google.android.apps.messaging; scheme=sms;S.browser_fallback_url=https%3A%2F%2Fbotlinks.dotgo.com%2Ffoot ball_club_android_no_rcs_row.html%0A;end”
(h) URI for iphone users in rest of world is of the form: “sms: dotgo-football-club@rbm.goog?bot-name=Football+Club&body=Hi”
(i) URI for users of a user device with other operating system in rest of world is of the form: “https://botlinks.dotgo.com/football_club_others_row.html”

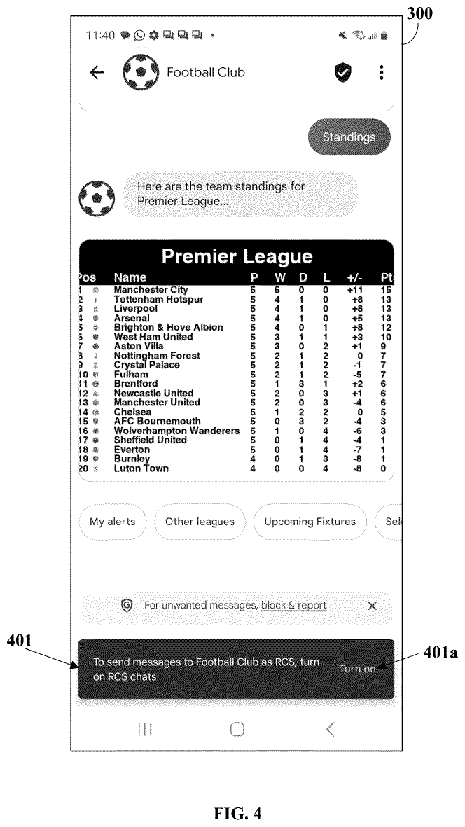

FIG. 4 exemplarily illustrates screenshot of a graphical user interface (GUI) 300 rendered on an Android user device with a messages client installed and the rich communication services (RCS) is not enabled for the messages client. The rich communication services person-to-application (RCSP2A) 208 receives RBM Agent information comprising a chatbot_service_id, a chatbot_name, and a trigger_keyword of the RBM Agent, from the brand and/or developer 201. The RCSP2A creates a person-to-application (P2A) deep-link 302 on a webpage 301 for the RBM Agent, as exemplarily illustrated in FIG. 3A, using the received RBM Agent information. Upon a user clicking the P2A deep-link 302, the RCSP2A 208 opens the messages client, with instructions 401 to turn on rich communication services chat for the messages client. The user can click on the “Turn on” link 401a and follow the process of enabling RCS chat, and then come back to start chatting with the RBM agent. Upon the user enabling the rich communication services chat for the messages client, the RCSP2A 208 initiates a chat with the RBM Agent specified by the chatbot_service_id and the chatbot_name in the intent: URI, with the trigger_keyword pre-populated, as exemplarily illustrated in FIG. 4. Upon enabling the RCS for the messages client, the user can start chatting with the RBM agent or resume chatting with the RBM agent with which the user has previously exchanged messages.

FIGS. 5A-5C exemplarily illustrates screenshots of a graphical user interface (GUI) 200 rendered on an Android user device without a messages client installed. The rich communication services person-to-application (RCSP2A) 208 receives RBM agent information comprising a chatbot_service_id, a chatbot_name, and a trigger_keyword of the RBM Agent, from the brand and/or developer 201. The RCSP2A 208 creates a person-to-application (P2A) deep-link 302 on a webpage 301 for the RBM agent, as exemplarily illustrated in FIG. 3A, using the received RBM agent information. Upon a user clicking the P2A deep-link 302, the RCSP2A 208 takes the user 205 to a first web page i.e., “alternative_web_page_with_instructions”, as specified by fallback uniform resource locator (URL) in the intent: URI, as exemplarily illustrated in FIG. 5A. The first web page i.e., “alternative_web_page_with_instructions”, contains instructions 501 to the user 205 to:
1. Install the Message app on Google Play.
2. Enable RCS Chats in Settings
3. Click the link below to start chatting with the Football bot.

Upon the user clicking the link to “Install the Message app on Google Play” on the first web page i.e., “alternative_web_page_with_instructions”, the user is taken to Google Play store to install the “Messages app” as exemplarily illustrated in FIG. 5B. After installing the “Messages app” the user is instructed to open the “Messages app” by clicking the button “Open” 502 as exemplarily illustrated in FIG. 5C, configure the installed “Messages app” as the default SMS app, and enable RCS chats. After setting “Messages app” as default SMS app and enabling the RCS chats for the messages client, i.e., “Messages app”, the user is returned to the web page 301, as exemplarily illustrated in FIG. 3A. Upon the user clicking the P2A deep-link 302 on the webpage 301, the RCSP2A 208 initiates a chat with the RBM Agent specified by the chatbot_service_id and the chatbot_name in the intent: URI, with the trigger_keyword pre-populated, for example, “start”, pre-populated, as exemplarily illustrated in FIG. 3B. The user can start chatting with the RBM agent or resume chatting with the RBM agent with which the user has previously exchanged messages.

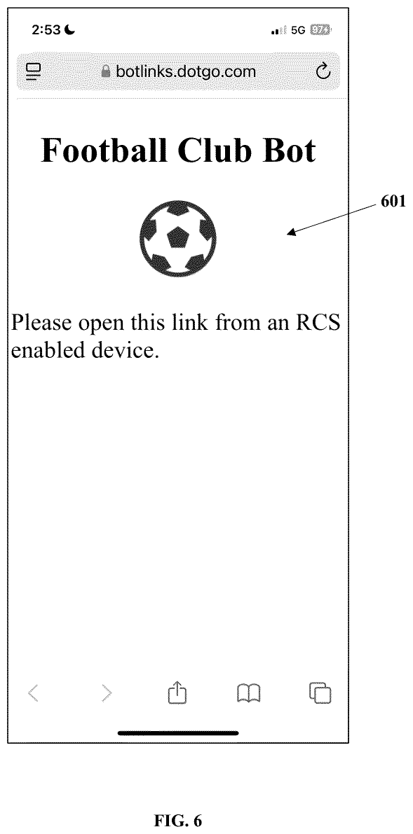

FIG. 6 exemplarily illustrates a screenshot of a graphical user interface (GUI) 600 rendered on a user device that does not support rich communication services (RCS). The rich communication services person-to-application (RCSP2A) 208 receives RBM agent information comprising a chatbot_service_id, a chatbot_name, and a trigger_keyword of the RBM Agent, from a brand and/or a developer 201. The RCSP2A 208 creates a person-to-application (P2A) deep-link 302 on a webpage 301 for the RBM Agent, as exemplarily illustrated in FIG. 3A, using the received RBM agent information. Upon a user clicking the P2A deep-link 302 on the webpage 301, the RCSP2A 208 displays a second web page 601 specified by the http: uniform resource identifier (URI) to the user, and notifies the user that RCS is not supported on the user device 205 and instructing the user to open the P2A deep-link from an RCS enabled device is displayed, as exemplarily illustrated in FIG. 6.

FIG. 7A exemplarily illustrates a screenshot of a quick-response (QR) Code 700 corresponding to the person-to-application (P2A) deep-link for the RBM agent, for example, “Mobile Ecosystem Forum”. The rich communication services person-to-application (RCSP2A) 208 receives RBM agent information comprising a chatbot_service_id, a chatbot_name, and a trigger_keyword of the RBM Agent, from a brand and/or a developer 201. The RCSP2A 208 creates a person-to-application (P2A) deep-link 302 on a webpage 301, using the received RBM agent information, as exemplarily illustrated in FIG. 3A. In an embodiment, the RCSP2A 208 generates a quick-response (QR) Code 700 corresponding to the P2A deep-link 302 for the RBM agent, as exemplarily illustrated in FIG. 7A. A user can scan the QR code 700 using the camera of a user device 205 to access the P2A deep-link 302 to the RBM Agent. In another embodiment, the P2A deep-link 302 can be converted to a short URL in order to track the users scanning the QR Code.

The QR code maps to the URL https://qrco.de/dotgoMEF, which is a short URL for the URI https://partner-dev.dotgo.com/mef.

The web page https://partner-dev.dotgo.com/mef redirects to:
For Android users:
   “intent: mobile-ecosystem-forum@rbm.goog?bot-name=Mobile+Ecosystem+Forum&body=start #Intent;package=com.g oogle.android.apps.messaging;scheme=sms;S.browser_fallback_url=ht tps%3A%2F%2Fbotlinks.dotgo.com%2Fmef_android_no_rcs.html %0A;end”;
For iphone users:
   “https://botlinks.dotgo.com/mef_iphone.html”
Other users:
   https://botlinks.dotgo.com/mef_others.html

FIG. 7B exemplarily illustrates a screenshot of an android user scanning a QR Code 700 for a person-to-application (P2A) deep-link. After scanning the QR Code 700 the P2A deep-link 701, for example, https://qrco.de/dogoMEF, is rendered on a user device of the android user. Upon clicking the P2A deep-link 701, if the android user has an RCS enabled messages application, the android user can start chatting with a RBM agent “Mobile Ecosystem Forum”, as exemplarily illustrated in FIG. 7C. Upon clicking the P2A deep-link 701, if the messages application is not installed on the user device of the android user, a web page 702 with instructions to install messages application is displayed on the user device, as exemplarily illustrated in FIG. 7D.

If an iPhone user scans the QR Code 700 for the P2A deep-link, after scanning the QR Code 700, a P2A deep-link 701, for example, “https://qrco.de/dogoMEF” is rendered on the iPhone. Upon clicking the P2A deep-link 701, if the iPhone user is in a country and/or a carrier without RCS messaging, a third web page 703 with a message “Sorry iPhone user—you cannot experience RCS. Please write to Apple to support RCS on iPhone” is displayed on the iPhone, as exemplarily illustrated in FIG. 7E.

Upon the iPhone user clicking the P2A deep-link 701, if the iPhone user is in a country and/or a carrier with rich communication services (RCS) messaging, a web page 704 with a message “RCS is now enabled on iOS 18 for many carriers. If you have RCS and RCS Business Messaging enabled on your iPhone, you can click on the image or link below to interact with the Football Club bot.” is displayed on the user's iPhone, as exemplarily illustrated in FIG. 7F. Upon the iPhone user clicking on the image 705 or a P2A link 706, as exemplarily illustrated in FIG. 7F, if the iPhone user has a RCS enabled device, the RCSP2A initiates a chat with the RBM agent specified by the chatbot_service_id and the chatbot_name in the sms: URI, with the trigger_keyword pre-populated, as exemplarily illustrated in FIG. 3C. The user can one of start chatting with the RCS business messaging (RBM) agent or resume chatting with the RBM agent with which the user has previously exchanged messages.

The foregoing examples and illustrative implementations of various embodiments have been provided merely for explanation and are in no way to be construed as limiting of the embodiments disclosed herein. While the embodiments have been described with reference to various illustrative implementations, drawings, and techniques, it is understood that the words, which have been used herein, are words of description and illustration, rather than words of limitation. Furthermore, although the embodiments have been described herein with reference to particular means, materials, techniques, and implementations, the embodiments herein are not intended to be limited to the particulars disclosed herein; rather, the embodiments herein extend to all functionally equivalent structures, methods, systems, and uses, such as are within the scope of the appended claims. It will be understood by those skilled in the art, having the benefit of the teachings of this specification, that the embodiments disclosed herein are capable of modifications and other embodiments may be effected and changes may be made thereto, without departing from the scope of the embodiments disclosed herein.

We claim:

1. A method for accessing a rich communication services (RCS) Business Messaging (RBM) agent, the method employing a rich communication services person-to-application (RCSP2A), executable by at least one processor configured to execute computer program instructions for performing the method, comprising:
receiving RBM agent information, by the RCSP2A, wherein the received RBM Agent information comprises a chatbot_service_id, a chatbot_name, and a trigger_keyword of the RBM agent;
creating, by the RCSP2A, a person-to-application (P2A) deep-link for the RBM agent, wherein the P2A deep-link is created using one of:
an intent: uniform resource identifier (URI) along with a browser fallback uniform resource locator (URL) for an android user;
an sms: URI for an iPhone operating system (iOS) user or a user of a user device with other operating system (OS) that supports the rich communication services (RCS); and
an htttp: URI for the users on other devices that do not support the RCS;
transmitting, by the RCSP2A, the created P2A deep-link to a user; and
upon clicking, by the user, the P2A deep-link:
(a) if the user is the android user with a RCS enabled device:
initiating a chat with the RBM agent specified by the chatbot_service_id and the chatbot_name in the intent: URI, with the trigger_keyword pre-populated, wherein the user can one of start chatting or resume chatting with the rich communication services (RCS) business messaging (RBM);
(b) if the user is the android user with a messages client installed on an android device, wherein the RCS is not enabled for the messages client:
opening the messages client, with instructions to turn on rich communication services chat for the messages client; and
upon the user enabling the rich communication services chat for the messages client, initiating a chat with the RBM Agent specified by the chatbot_service_id and the chatbot_name in the intent: URI, with the trigger_keyword pre-populated, and enabling the user to one of start chatting or resume chatting with the RBM agent;
(c) if the user is the android user with the messages client not installed on the android device:
opening a first web page specified by the fallback URL in the intent: URI and providing instructions to the user to:
i. click on a link to Google Play store to install the messages client;
ii. turn on rich communication services chat features; and
iii. click the P2A deep-link created using the intent: URI;
upon the user enabling the rich communication services chat for the messages client, initiating a chat with the RBM Agent specified by the chatbot_service_id and the chatbot_name in the intent: URI, with the trigger_keyword pre-populated, and enabling the user to one of start chatting or resume chatting with the RBM agent;
(d) if the user is the iOS user or the user of the user device with other OS that supports the RCS:
initiating a chat with the RBM Agent specified by the chatbot_service_id and the chatbot_name in the sms: URI, with the trigger_keyword pre-populated, wherein the user can one of start chatting or resume chatting with the RBM agent; and
(e) if a user device does not support the RCS:
displaying a second web page specified by the http: URI to the user, and notifying the user that the RCS is not supported on the user device.

2. The method of claim 1, wherein the URI used for the android users is of the form:
“intent: <chatbot_service_id>?bot-name=<chatbot_name>&body=<trigger_keyword> #Intent;scheme=sms;package=co m.google.android.apps.messaging;S.browser_fallback_url=<alternative_web_page_with_instructions>;end”.

3. The method of claim 1, wherein the URI used for the iOS users and the users of the user device with other OS that support the RCS is of the form:
“sms: <chatbot service_id>?bot-name=<chatbot_name>&body=<trigger_keyword>”.

4. The method of claim 1, wherein the URI used for the users on other user devices that do not support the RCS is of the form:
“http://<alternative_web_page_with_instructions>”.

5. The method of claim 1, wherein the users are redirected to different URIs based on their user device, country, and carrier, wherein the user device comprises Android, IOS, or other user devices.

6. The method of claim 1, wherein the RCSP2A creates a quick-response (QR) code (QR Code) corresponding to the P2A deep-link for the RBM agent, and wherein the user can scan the QR Code to access the P2A deep-link to the RBM agent.

7. The method of claim 1, wherein the P2A deep-link is provided as a service to brands and/or developers by an RCSP2A provider.

8. The method of claim 7, wherein the RCSP2A provider is also a RBM platform provider for the brands and/or the developers to onboard and launch multiple RBM agents.

9. The method of claim 8, wherein a carrier partners with the RCSP2A provider to offer the P2A deep-link service for the multiple RBM agents launched on a carrier's network.

10. The method of claim 9, wherein the RCSP2A provider is also a RBM platform provider for the brands and/or the developers to onboard and launch the multiple RBM agents on the carrier's network.

11. The method of claim 10, wherein the carrier uses a different platform for onboarding and launching the multiple RBM agents on the carrier's network.

12. The method of claim 8, wherein the RCSP2A provider partners with one of Google Jibe, another messaging-as-a-platform, and a RBM platform to provide the P2A deep-link service for some or all of the multiple RBM agents launched on a partner platform.

13. A system for accessing a rich communication services (RCS) Business Messaging (RBM) agent, the system comprising:
at least one processor communicatively couples to a non-transitory, computer-readable storage medium;
the non-transitory, computer-readable storage medium configured to store computer program instructions executable by the at least one processor; and
a rich communication services person-to-application (RCSP2A) defining the computer program instructions, which when executed by the at least one processor, causes the at least one processor to:
receive RBM agent information, wherein the received RBM Agent information comprises a chatbot_service_id, a chatbot_name, and a trigger_keyword of the RBM agent;
create a person-to-application (P2A) deep-link for the RBM agent, wherein the P2A deep-link is created using one of:
an intent: uniform resource identifier (URI) along with a browser fallback uniform resource locator (URL) for an android user;
an sms: URI for an iOS user or a user of a user device with another OS that supports the rich communication services (RCS); and
an htttp: URI for the users on other devices that do not support the RCS;
transmit the created P2A deep-link to the user; and
upon clicking, by the user, the P2A deep-link:
(a) if the user is the android user with a RCS enabled device:
initiate a chat with the RBM Agent specified by the chatbot_service_id and the chatbot_name in the intent: URI, with the trigger_keyword pre-populated, wherein the user can one of start chatting or resume chatting with the rich communication services (RCS) business messaging (RBM) agent;
(b) if the user is the android user with a messages client installed on an android device, wherein the RCS is not enabled for the messages client:
open the messages client, with instructions to turn on rich communication services chat for the messages client; and
upon the user enabling the rich communication services chat for the messages client, initiate a chat with the RBM Agent specified by the chatbot_service_id and the chatbot_name in the intent: URI, with the trigger_keyword pre-populated, and enable the user to one of start chatting or resume chatting with the RBM agent;
(c) if the user is the android user with the messages client not installed on the android device:
open a first web page specified by the fallback URL in the intent: URI and provide instructions to the user to:
i. click on a link to Google Play store to install the messages client;
ii. turn on rich communication services chat features; and
iii. click the P2A deep-link created using the intent: URI;
upon the user enabling the rich communication services chat for the messages client, initiate a chat with the RBM Agent specified by the chatbot_service_id and the chatbot_name in the intent: URI, with the trigger_keyword pre-populated, and enable the user to one of start chatting or resume chatting with the RBM agent;
(d) if the user is the iOS user or the user of the user device with another OS that supports the RCS:
initiate a chat with the RBM Agent specified by the chatbot_service_id and the chatbot_name in the sms: URI, with the trigger_keyword pre-populated, wherein the user can one of start chatting or resume chatting with the RBM agent; and
(e) if a user device does not support the RCS:
display a second web page specified by the http: URI to the user, and notify the user that the RCS is not supported on the user device.

14. The system of claim 13, wherein the users are redirected to different URIs based on types of the user device, wherein the types of the user device comprise Android, IOS, or other type of the user device.

15. The system of claim 13, wherein the RCSP2A creates a quick-response (QR) code (QR Code) corresponding to the P2A deep-link for the RBM agent, and wherein the user can scan the QR Code to access the P2A deep-link to the RBM agent.

16. The system of claim 13, wherein the P2A deep-link is provided as a service to brands and/or developers by an RCSP2A provider.

17. The system of claim 16, wherein the RCSP2A provider is also a RBM platform provider for the brands and/or the developers to onboard and launch multiple RBM agents.

18. The system of claim 17, wherein a carrier partners with the RCSP2A provider to offer the URI link service for the multiple RBM agents launched on a carrier's network.

19. The system of claim 18, wherein the RCSP2A provider is also a RBM platform provider for the brands and/or the developers to onboard and launch the multiple RBM agents on the carrier's network.

20. The system of claim 19, wherein the carrier uses a different platform for onboarding and launching the multiple RBM agents on the carrier's network.
